(19) United States
(12) Patent Application Publication
(10) Pub. No.: US 2026/0163211 A1
(43) Pub. Date: Jun. 11, 2026

(54) ALL-SOLID-STATE BATTERY

(71) Applicant: SAMSUNG ELECTRO-MECHANICS CO., LTD., Suwon-si, Gyeonggi-do (KR)

(72) Inventors: Youngil Lee, Suwon-si, Gyeonggi-do (KR); Kyunglock Kim, Suwon-si, Gyeonggi-do (KR); Sanghoon Ha, Suwon-si, Gyeonggi-do (KR); Junhyeon Kim, Suwon-si, Gyeonggi-do (KR); Han Kim, Suwon-si, Gyeonggi-do (KR); Kwangjik Lee, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/716,484

(22) PCT Filed: May 2, 2024
(86) PCT No.: PCT/KR2024/005924

§ 371 Date: Jun. 4, 2024

(30) Foreign Application Priority Data
Oct. 24, 2023 (KR) 10-2023-0142694
Jan. 2, 2024 (KR) 10-2024-0000434

(51) Int. Cl. H01M 50/548; H01M 10/0562; H01M 10/0585; H01M 50/533; H01M 50/562

(52) U.S. Cl. CPC H01M 50/548; H01M 10/0562; H01M 10/0585; H01M 50/533; H01M 50/562

(57) ABSTRACT

An all-solid-state battery includes: a laminate including a first surface and a second surface facing each other in a first direction, a positive electrode layer, a negative electrode layer, and a solid electrolyte layer disposed between the positive electrode layer and the negative electrode layer and including a solid electrolyte; a first thin-film electrode that is directly connected to the positive electrode layer and the solid electrolyte layer on the first surface of the laminate; a second thin-film electrode that is directly connected to the negative electrode layer and the solid electrolyte layer on the second surface of the laminate; a first external electrode that is connected to the first thin-film electrode and covers at least a portion of the laminate; and a second external electrode that is connected to the second thin-film electrode and covers at least a portion of the laminate.

### TECHNICAL FIELD

The present disclosure relates to an all-solid-state battery.

### BACKGROUND ART

As a portable electronic device has recently been required to be downsized and be used for a long time, a high-capacity battery is required, and safety of the battery is required due to popularization of a wearable electronic device.

Because a lithium ion battery currently commercially available in the market uses a liquid electrolyte including a combustible organic solvent, there is a possibility of overheating and fire if a short circuit occurs. Accordingly, an all-solid-state battery using a solid electrolyte instead of the liquid electrolyte is being proposed.

If an electrode layer (a positive electrode layer or a negative electrode layer) and an external electrode of the all-solid-state battery are not uniformly connected, a flow of a stable current may be hindered so that unstable charging and discharging of the battery occur.

### DISCLOSURE OF INVENTION

### Technical Problem

One aspect of an embodiment is to provide an all-solid-state battery capable of ensuring stable charging and discharging by uniformly connecting an electrode layer and an external electrode.

However, a problem to be solved by embodiments of the present disclosure is not limited to the above-described problem, and may be variously expanded in a range of a technical idea included in the present disclosure.

### Solution to Problem

An all-solid-state battery according to an embodiment includes: a laminate including a first surface and a second surface opposing each other in a first direction, a third surface and a fourth surface opposing each other in a second direction and connecting the first surface and the second surface, and a fifth surface and a sixth surface opposing each other in a third direction and connecting the first surface and the second surface, a positive electrode layer, a negative electrode layer, and a solid electrolyte layer disposed between the positive electrode layer and the negative electrode layer and including a solid electrolyte; a first thin-film electrode that is directly connected to the positive electrode layer and the solid electrolyte layer on the first surface of the laminate; a second thin-film electrode that is directly connected to the negative electrode layer and the solid electrolyte layer on the second surface of the laminate; a first external electrode that is connected to the first thin-film electrode and covers at least a portion of the laminate; and a second external electrode that is connected to the second thin-film electrode and covers at least a portion of the laminate.

The first external electrode and the second external electrode may include silver (Ag).

The first external electrode and the second external electrode may include a base resin and a conductive metal including silver (Ag).

The base resin may include an epoxy resin.

The first thin-film electrode and the second thin-film electrode may be a sputter electrode.

A thickness of the first thin-film electrode may be 50 nm or more and 1 μm or less, and a thickness of the second thin-film electrode may be 50 nm or more and 1 μm or less.

A thickness of the first thin-film electrode may be 50 nm or more and 500 nm or less, and a thickness of the second thin-film electrode may be 50 nm or more and 500 nm or less.

At least one of a thickness of the first thin-film electrode and a thickness of the second thin-film electrode may be 50 nm or more and 500 nm or less.

The first thin-film electrode may cover a portion of the first surface of the laminate, and the second thin-film electrode may cover a portion of the second surface of the laminate.

The first external electrode may cover the first thin-film electrode and may cover a portion of the first surface of the laminate where the first thin-film electrode is not disposed, and the second external electrode may cover the second thin-film electrode and may cover a portion of the second surface of the laminate where the second thin-film electrode is not disposed.

The first external electrode may cover a portion of the fifth surface and a portion of the sixth surface of the laminate, and the second external electrode may cover another portion of the fifth surface and another portion of the sixth surface of the laminate.

The first thin-film electrode may entirely cover the first surface of the laminate, and the second thin-film electrode may entirely cover the second surface of the laminate.

The first external electrode may cover the first thin-film electrode and may cover a portion of the fifth surface and a portion of the sixth surface of the laminate, and the second external electrode may cover the second thin-film electrode and may cover another portion of the fifth surface and another portion of the sixth surface of the laminate.

The first thin-film electrode may entirely cover the first surface of the laminate, and the second thin-film electrode may entirely cover the second surface of the laminate.

The first external electrode may entirely cover the first thin-film electrode, and the second external electrode may entirely cover the second thin-film electrode.

The first thin-film electrode and the second thin-film electrode may include platinum (Pt), gold (Au), nickel (Ni), chromium (Cr), molybdenum (Mo), or a combination thereof.

The positive electrode layer may include a positive electrode current collector and a positive electrode active material layer, and the negative electrode layer may include a negative electrode active material layer.

An all-solid-state battery according to an embodiment includes: a laminate including a first surface and a second surface opposing each other in a first direction, a third surface and a fourth surface opposing each other in a second direction and connecting the first surface and the second surface, and a fifth surface and a sixth surface opposing each other in a third direction and connecting the first surface and the second surface, a positive electrode layer, a negative electrode layer, and a solid electrolyte layer disposed between the positive electrode layer and the negative electrode layer and including a solid electrolyte; a first external electrode disposed at least on the first surface; a second external electrode disposed at least on the second surface; a first metal electrode disposed on the first surface to connect the positive electrode layer to the first external electrode; and a second metal electrode disposed on the second surface to connect the negative electrode layer to the second external electrode.

A metal included in the first metal electrode may extend continuously from the positive electrode layer to the first external electrode, and a metal included in the second metal electrode may extend continuously from the negative electrode layer to the second external electrode.

One of a thickness of the first metal electrode and a thickness of the second metal electrode may be 50 nm or more and 1 μm or less.

One of a thickness of the first metal electrode and a thickness of the second metal electrode may be 50 nm or more and 500 nm or less.

One of a thickness of the first metal electrode and a thickness of the second metal electrode may be 200 nm or more and 1 μm or less.

An all-solid-state battery according to an embodiment includes: a laminate including a first surface and a second surface opposing each other in a first direction, a third surface and a fourth surface opposing each other in a second direction and connecting the first surface and the second surface, and a fifth surface and a sixth surface opposing each other in a third direction and connecting the first surface and the second surface, a positive electrode layer, a negative electrode layer, and a solid electrolyte layer disposed between the positive electrode layer and the negative electrode layer and including a solid electrolyte; a first external electrode disposed at least on the first surface; a second external electrode disposed at least on the second surface; a first electrode disposed on the first surface to connect the positive electrode layer to the first external electrode and having a thickness of 1 μm or less; and a second electrode disposed on the second surface to connect the negative electrode layer to the second external electrode and having a thickness of 1 μm or less.

One of the thickness of the first electrode and the thickness of the second electrode may be 50 nm or more and 1 μm or less.

One of the thickness of the first electrode and the thickness of the second electrode may be 50 nm or more and 500 nm or less.

One of the thickness of the first electrode and the thickness of the second electrode may be 200 nm or more and 1 μm or less.

### Advantageous Effects of Invention

According to the all-solid-state battery according to the embodiment, an electrode layer and an external electrode are uniformly connected to secure stable charging and discharging.

### BRIEF DESCRIPTION OF DRAWINGS

FIG. 1 is a perspective view schematically showing an all-solid-state battery according to an embodiment.

FIG. 2 is a perspective view schematically showing a laminate of the all-solid-state battery of FIG. 1.

FIG. 3 is a cross-sectional view taken along a line III-III′ of FIG. 1.

FIG. 4A is a partial cross-sectional view schematically showing a positive electrode layer of the all-solid-state battery of FIG. 1.

FIG. 4B is a partial cross-sectional view schematically showing a negative electrode layer of the all-solid-state battery of FIG. 1.

FIG. 5 is a scanning electron microscope photograph showing a result of depositing a first thin-film electrode with a 300 nm to 400 nm sputtering target.

FIG. 6 is a scanning electron microscope photograph showing a result of depositing the first thin-film electrode with a 500 nm to 600 nm sputtering target.

FIG. 7 is a scanning electron microscope photograph showing a result of depositing the first thin-film electrode with a 1000 nm sputtering target.

FIG. 8 is a scanning electron microscope photograph showing a result of depositing a second thin-film electrode with a 300 nm to 400 nm sputtering target.

FIG. 9 is a scanning electron microscope photograph showing a result of depositing the second thin-film electrode with a 500 nm to 600 nm sputtering target.

FIG. 10 is a scanning electron microscope photograph showing a result of depositing the second thin-film electrode with a 1000 nm sputtering target.

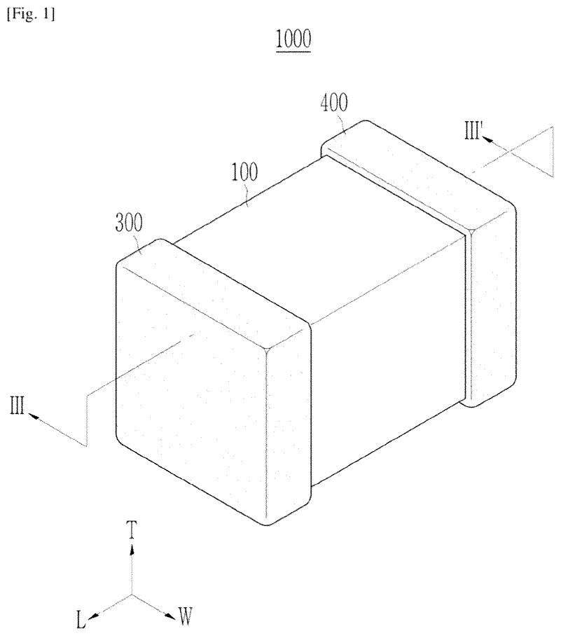

FIG. 1 is a cross-sectional view schematically showing an all-solid-state battery according to another embodiment.

FIG. 12 is a cross-sectional view schematically showing an all-solid-state battery according to another embodiment.

FIG. 13A is a graph showing a result of a charging and discharging repetition cycle test of an all-solid-state battery according to Example 1.

FIG. 13B is a graph showing a result of a charging and discharging repetition cycle test of an all-solid-state battery according to Example 2.

FIG. 13C is a graph showing a result of a charging and discharging repetition cycle test of an all-solid-state battery according to Example 3.

FIG. 13D is a graph showing a result of a charging and discharging repetition cycle test of an all-solid-state battery according to Example 4.

FIG. 13E is a graph showing a result of a charging and discharging repetition cycle test of an all-solid-state battery according to Example 5.

FIG. 13F is a graph showing a result of a charging and discharging repetition cycle test of an all-solid-state battery according to Example 6.

FIG. 13G is a graph showing a result of a charging and discharging repetition cycle test of an all-solid-state battery according to Example 7.

FIG. 13H is a graph showing a result of a charging and discharging repetition cycle test of an all-solid-state battery according to Comparative Example.

FIG. 14 is a graph showing a change in a capacity retention ratio according to a thickness of a thin-film electrode of the all-solid-state battery according to an embodiment.

### MODE FOR THE INVENTION

Hereinafter, with reference to accompanying drawings, an embodiment of the present disclosure will be described in detail and thus a person of ordinary skill can easily practice it in the technical field to which the present disclosure belongs. The drawings and description are to be regarded as illustrative in nature and not restrictive. Like reference numerals designate like elements throughout the specification. In addition, in the accompanying drawing, some constituent elements are exaggerated, omitted, or schematically shown, and the size of each constituent element does not fully reflect the actual size.

The accompanying drawings are only for easy understanding of the embodiment disclosed in this specification, and the technical idea disclosed in this specification is not limited by the accompanying drawings, and it should be understood that all changes and equivalents or substitutes are included in the spirit and technical range of the present disclosure.

Terms containing ordinal numbers, such as first, second, and the like may be used to describe various configurations elements, but the constituent elements are not limited by the terms. The terms are used only for the purpose of distinguishing one constituent element from another.

It will be understood that when an element such as a layer, film, region, or substrate is referred to as being “on” or “above” another element, it may be directly on the other element or intervening elements may also be present. In contrast, when an element is referred to as being “directly on” another element, there are no intervening elements present. Further, throughout the specification, the word “on” or “above” a target element will be understood to mean positioned above or below the target element, and will not necessarily be understood to mean positioned “at an upper side” based on an opposite to gravity direction.

Throughout the specification, terms such as “comprise” or “have” are intended to designate that a feature, number, step, operation, constituent element, part, or combination thereof described in the specification exists, and it should be understood as not precluding the possibility of the presence or addition of and one or more other features, numbers, steps, actions, constituent elements, parts, or combinations thereof. In addition, unless explicitly described to the contrary, the word “comprise”, and variations such as “comprises” or “comprising”, will be understood to imply the inclusion of stated elements but not the exclusion of any other elements.

Further, throughout the specification, the phrase “on a plane” means viewing a target portion from the top, and the phrase “on a cross-section” means viewing a cross-section formed by vertically cutting a target portion from the side.

Throughout the specification, “connected” does not mean only when two or more constituent elements are directly connected, but also when two or more constituent elements are indirectly connected through another constituent element, or when physically connected or electrically connected, and it may include a case in which substantially integral parts are connected to each other although they are referred to by different names according to positions or functions.

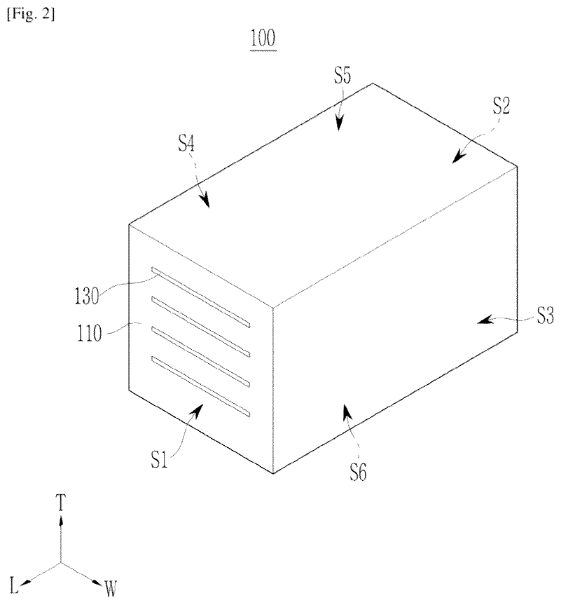

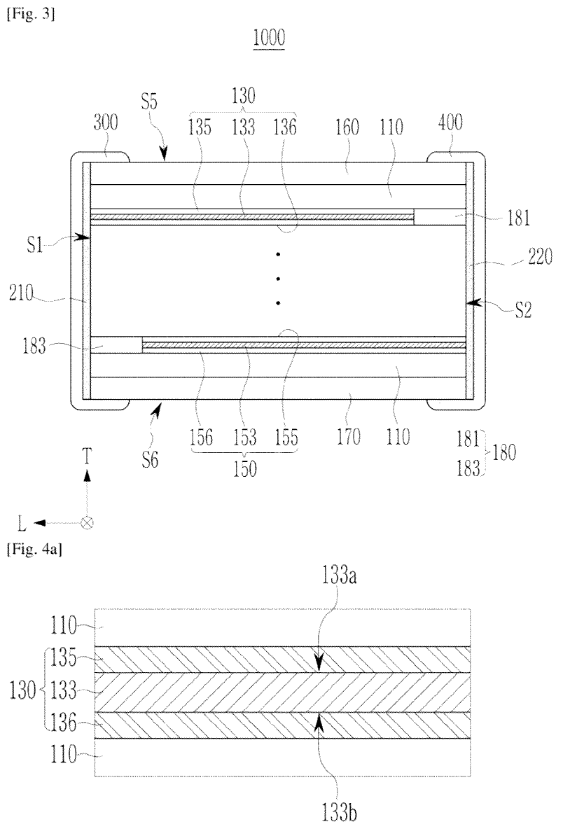

FIG. 1 is a perspective view schematically showing an all-solid-state battery according to an embodiment, FIG. 2 is a perspective view schematically showing a laminate of the all-solid-state battery of FIG. 1, and FIG. 3 is a cross-sectional view taken along a line III-III′ of FIG. 1.

Referring to FIGS. 1, 2, and 3, the all-solid-state battery 1000 according to the present embodiment includes a laminate 100, a first thin-film electrode 210, a second thin-film electrode 220, a first external electrode 300, and a second external electrode 400.

First, a direction is defined to clearly describe the present embodiment. An L-axis, a W-axis, and a T-axis shown in the drawings represent a length direction, a width direction, and a thickness direction of the all-solid-state battery 1000, respectively.

The thickness direction (T-axis direction) may be a direction perpendicular to a wide surface (a main surface) of a constituent element having a sheet shape. For example, the thickness direction (T-axis direction) may be used as the same concept as a direction in which the laminate 100 is stacked.

The length direction (L-axis direction) may be a direction parallel to the wide surface (the main surface) of the constituent element having the sheet shape, and may be a direction that intersects (or is perpendicular to) the thickness direction (T-axis direction). For example, the length direction (L-axis direction) may be a direction in which the first external electrode 300 and the second external electrode 400 oppose each other.

The width direction (W-axis direction) may be a direction parallel to the wide surface (the main surface) of the constituent element having the sheet shape, and may be a direction that simultaneously intersects (or is perpendicular to) the thickness direction (T-axis direction) and the length direction (L-axis direction).

The laminate 100 may have an approximately hexahedral shape, but the present embodiment is not limited thereto. Due to shrinkage during sintering, the laminate 100 may not have a complete hexahedral shape, but may have a substantially hexahedral shape. For example, the laminate 100 may have an approximately rectangular parallelepiped shape, but a portion corresponding to a corner or a vertex may have a round shape.

For convenience of description of the present embodiment, surfaces opposing each other in the length direction (L-axis direction) are defined as a first surface S1 and a second surface S2, surfaces opposing each other in the width direction (W-axis direction) and connecting the first surface S1 and the second surface S2 are defined as a third surface S3 and a fourth surface S4, and surfaces opposing each other in the thickness direction (T-axis direction) and connecting the first surface S1 and the second surface S2 are defined as a fifth surface S5 and a sixth surface S6.

Therefore, a first direction that is a direction in which the first surface S1 and the second surface S2 oppose each other may be the length direction (L-axis direction), and second and third directions perpendicular to the first direction and perpendicular to each other may be the thickness direction (T-axis direction) and the width direction (W-axis direction) or the width direction (W-axis direction) and the thickness direction (T-axis direction), respectively.

Based on an optical microscope or scanning electron microscope (SEM) photograph of a cross-section (taken in the length direction (L-axis direction) and the thickness direction (T-axis direction)) at a central portion of the laminate 100 in the width direction (W-axis direction), a length of the laminate 100 may mean a maximum value among lengths of a plurality of line segments that connects two outermost boundary lines, which are opposite to each other in the length direction (L-axis direction) of the laminate 100 shown in the above-mentioned photograph, and is parallel to the length direction (L-axis direction). Meanwhile, the length of the laminate 100 may mean a minimum value among the lengths of the plurality of line segments that connects the two outermost boundary lines, which are opposite to each other in the length direction (L-axis direction) of the laminate 100 shown in the above-mentioned photograph, and is parallel to the length direction (L-axis direction). In the meantime, the length of the laminate 100 may mean an arithmetic mean value of the lengths of at least two line segments among the plurality of line segments that connects the two outermost boundary lines, which are opposite to each other in the length direction (L-axis direction) of the laminate 100 shown in the above-mentioned photograph, and is parallel to the length direction (L-axis direction).

Based on an optical microscope or scanning electron microscope (SEM) photograph of the cross-section (taken in the length direction (L-axis direction) and the thickness direction (T-axis direction)) at a central portion of the laminate 100 in the width direction (W-axis direction), a thickness of the laminate 100 may mean a maximum value among the lengths of the plurality of line segments that connects two outermost boundary lines, which are opposite to each other in the thickness direction (T-axis direction) of the laminate 100 shown in the above-mentioned photograph, and is parallel to the thickness direction (T-axis direction). Meanwhile, the thickness of the laminate 100 may mean a minimum value among the lengths of the plurality of line segments that connects the two outermost boundary lines, which are opposite to each other in the thickness direction (T-axis direction) of the laminate 100 shown in the above-mentioned photograph, and is parallel to the thickness direction (T-axis direction). In the meantime, the thickness of the laminate 100 may mean an arithmetic mean value of the lengths of at least two line segments among the plurality of line segments that connects the two outermost boundary lines, which are opposite to each other in the thickness direction (T-axis direction) of the laminate 100 shown in the above-mentioned photograph, and is parallel to the thickness direction (T-axis direction).

Based on an optical microscope or scanning electron microscope (SEM) photograph of a cross-section (taken in the length direction (L-axis direction) and the width direction (W-axis direction)) at a central portion of the laminate 100 in the thickness direction (T-axis direction), a width of the laminate 100 may mean a maximum value among lengths of a plurality of line segments that connects two outermost boundary lines, which are opposite to each other in the width direction (W-axis direction) of the laminate 100 shown in the above-mentioned photograph, and is parallel to the width direction (W-axis direction). Meanwhile, the width of the laminate 100 may mean a minimum value among the lengths of the plurality of line segments that connects the two outermost boundary lines, which are opposite to each other in the width direction (W-axis direction) of the laminate 100 shown in the above-mentioned photograph, and is parallel to the width direction (W-axis direction). In the meantime, the width of the laminate 100 may mean an arithmetic mean value of the lengths of at least two line segments among the plurality of line segments that connects the two outermost boundary lines, which are opposite to each other in the width direction (W-axis direction) of the laminate 100 shown in the above-mentioned photograph, and is parallel to the width direction (W-axis direction).

The laminate 100 may include a solid electrolyte layer 110, a positive electrode layer 130, a negative electrode layer 150, an upper protective layer 160, a lower protective layer 170, and a margin portion 180.

The laminate 100 may include a plurality of solid electrolyte layer 110, a plurality of positive electrode layer 130, and a plurality of negative electrode layer 150. The positive electrode layer 130 and the negative electrode layer 150 may be alternately stacked in the thickness direction (T-axis direction) with the solid electrolyte layer 110 interposed therebetween. This stacked structure may repeat within the laminate 100, an electrode layer closest to the fifth surface S5 of the laminate 100 may be the positive electrode layer 130 or the negative electrode layer 150, and an electrode layer closest to the sixth surface S6 may be the negative electrode layer 150 or the positive electrode layer 130.

The positive electrode layer 130 may be disposed on one surface of the solid electrolyte layer 110, and the negative electrode layer 150 may be disposed on the other surface of the solid electrolyte layer 110.

The solid electrolyte layer 110 includes a solid electrolyte. The solid electrolyte may serve as a passage for lithium (Li) ions.

The solid electrolyte included in the solid electrolyte layer 110 may include a glass-ceramic-based electrolyte including lithium-halide (LiX wherein X is a halogen element such as F, Br, Cl, I, or the like). The glass-ceramic (or a crystallization glass) refers to a crystallographic mixture of amorphous and crystalline materials from which peaks and halos are observed in X-ray diffraction, electron beam diffraction, or the like. Therefore, the glass-ceramic-based electrolyte is an electrolyte that has undergone partial crystallization through sintering and in which amorphous and crystalline materials are mixed.

The glass-ceramic-based electrolyte may be a mixture of an amorphous material and two or more types of crystalline materials. Further, the crystalline materials which are contained in the glass-ceramic-based electrolyte may include a lithium-compound crystalline phase containing lithium.

When the glass-ceramic-based electrolyte is contained in the solid electrolyte layer 110, sufficient densification is achieved after sintering, whereby it is possible to realize high ionic conductivity.

The glass-ceramic-based electrolyte may include at least one selected from the group consisting of lithium (Li) oxide, boron (B) oxide, silicon (Si) oxide, aluminum (Al) oxide, gallium (Ga) oxide, phosphorus (P) oxide, germanium (Ge) oxide, magnesium (Mg) oxide, and lithium chloride (LiCl). As a specific example, the glass-ceramic-based electrolyte may include Li₂O—B₂O₃—SiO₂—P₂O₅—GeO₂—LiCl.

Alternatively, the solid electrolyte contained in the solid electrolyte layer 110 may include a lithium-borosilicate-based electrolyte (hereinafter, also referred to as an LBSO-based electrolyte). The LBSO-based electrolyte is a glass-state electrolyte, and glass refers to a crystallographically amorphous material from which halos are observed in X-ray diffraction, electron beam diffraction, etc.

When the LBSO-based electrolyte is contained in the solid electrolyte layer 110, it is possible to keep the amorphous state during sintering while lowering the sintering temperature. Therefore, there is an advantage that it is possible to realize high ionic conductivity, and reactivity with the electrode is not high. The LBSO-based electrolyte may include lithium (Li), boron (B), silicon (Si), aluminum (Al), phosphorus (P), germanium (Ge), and sulfur (S).

Alternatively, the solid electrolyte contained in the solid electrolyte layer 110 may be one or more types selected from the group consisting of a Garnet-type, a Na super ionic conductor (NASICON)-type, a lithium super ionic conductor (LISICON)-type, a Perovskite-type, and a lithium phosphorus oxynitride (LiPON)-type.

In some embodiments, the solid electrolyte layer 110 may include first and second margin portions 181 and 183. The first and second margin portions 181 and 183, to be described later, may include a material having a low ionic conductivity and electrical conductivity, i.e., an insulating material, or a material having ionic conductivity (or electrical conductivity) similar to the ionic conductivity (or electrical conductivity) of the solid electrolyte. For example, the material having ionic conductivity (or electrical conductivity) similar to the ionic conductivity (or electrical conductivity) of the solid electrolyte included in the first and second margin portions 181 and 183 may be a material identical to or different from the solid electrolyte in other regions. As another example, a material having ionic conductivity (or electrical conductivity) similar to the ionic conductivity (or electrical conductivity) of the solid electrolyte and an insulating material may coexist in the region.

The Garnet-type solid electrolyte may refer to lithium-lanthanum-zirconium oxide (LLZO) represented by LiₐLa_{b}Zr_{c}O₁₂ such as Li₇La₃Zr₂O₁₂, and the NASICON-type solid electrolyte may include lithium-aluminum-titanium-phosphate (LATP) of Li₁₊ₓAlₓTi₂₋ₓ(PO₄)₃ (wherein 0<x<1) produced by introducing Ti to Li₁₊ₓAlₓM₂₋ₓ(PO₄)₃ (LAMP) (wherein (<x<2 and M is Zr, Ti, or Ge) type compound, lithium-aluminum-germanium-phosphate (LAGP) represented by Li₁₊ₓAlₓGe₂₋ₓ(PO₄)₃ (wherein 0<x<1), such as Li_{1.3}Al_{0.3}Ge_{1.7}(PO₄)₃ containing an excessive amount of lithium, and/or lithium-zirconium-phosphate (LZP) LiZr₂(PO₄).

In addition, the LISICON-type solid electrolyte may include solid solution oxide represented by xLi₃AO₄-(1-x)Li₄BO₂ (wherein A is P, As, V, etc., and B is Si, Ge, Ti, etc.), such as Li₄Zn(GeO₄)₄, Li₁₀GeP₂O₁₂(LGPO), Li_{3.5}Si_{0.5}P_{0.5}O₄, Li₁₀₋₄₂Si(Ge)_{1.5}P_{1.5}Cl_{0.08}O_{11.92}, etc., and solid solution sulfide represented by Li₄₋ₓM_{1-y}M′_{y}S₂ (wherein M is Si or Ge and M′ is P, Al, Zn, or Ga), such as Li₂S—P₂S₅, Li₂S—SiS₂, Li₂S—SiS₂—P₂S₅, Li₂S—GeS₂, etc.

Further, the Perovskite-type solid electrolyte include to lithium-lanthanum-titanium-oxide (LLTO) represented by Li₃ₓLa_{2/3-x}□_{1/3-2x}TiO₃ (wherein 0<x<0.16, and □ is vacancy), such as Li_{1/8}La_{5/8}TiO₃. The LiPON-type solid electrolyte may refer to nitride such as lithium phosphorous oxynitride such as Li_{2.8}PO_{3.3}N_{0.46}.

The positive electrode layer 130 may be exposed outside of the laminate 100 from the first surface S1 of the laminate 100, and may be connected to the first thin-film electrode 210.

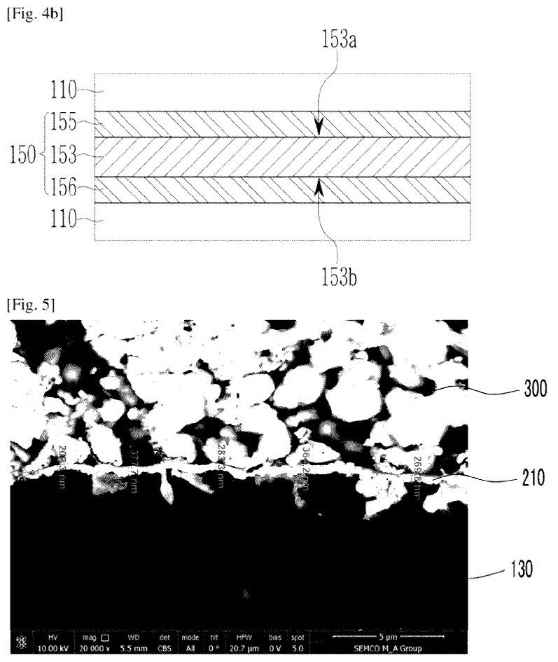

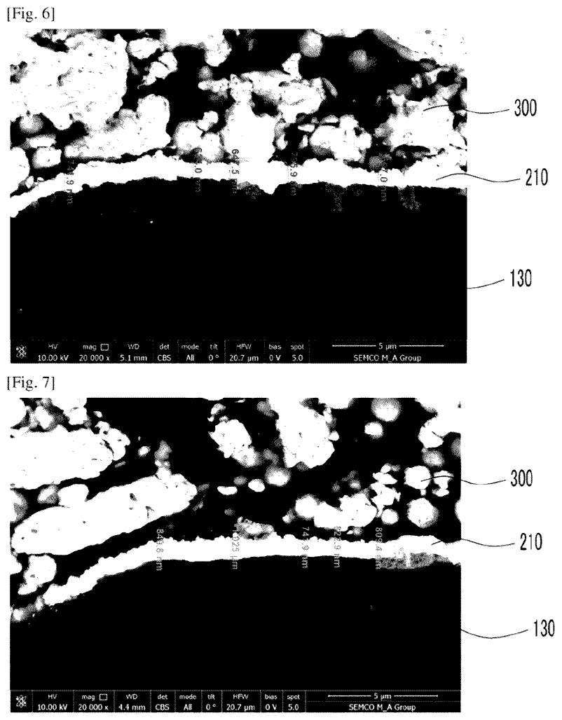

Referring to FIG. 3 and FIG. 4A, the positive electrode layer 130 may include a positive electrode current collector 133, a first positive electrode active material layer 135, and a second positive electrode active material layer 136.

For example, the positive electrode current collector 133 may be made of a plate-shaped member or a thin member. As another example, the positive electrode current collector 133 may be a porous body having a reticulate shape, a mesh shape, or the like.

The positive electrode current collector 133 may include a first surface 133a and a second surface 133b. The first surface 133a and the second surface 133b oppose each other in the thickness direction (T-axis direction).

For example, the positive electrode current collector 133 may include, but not limited to, a porous metal plate made of stainless steel, nickel (Ni), copper (Cu), tin (Sn), aluminum (Al), or an alloy thereof.

In addition, the positive electrode current collector 133 may be coated with an oxidation-resistant metal or alloy film to prevent oxidation.

The positive electrode current collector 133 may include a carbon-based plate-shaped, thin, linear, or circular member. The positive electrode current collector 133 may include a conductive carbon material. The conductive carbon material may include graphite, conductive fiber such as carbon nanotube (CNT) or vapor grown carbon fiber (VGCF), or conductive carbon such as carbon black.

Meanwhile, the positive electrode current collector may also include one or more types of solid electrolytes.

The first positive electrode active material layer 135 and the second positive electrode active material layer 136 may include positive electrode active materials, and may be disposed on a surface of the positive electrode current collector 133. The first positive electrode active material layer 135 and the second positive electrode active material layer 136 may be formed by printing a positive active material on one or both surfaces of the positive electrode current collector 133. However, the method for forming the positive electrode active material layer is not limited thereto.

The positive electrode active material included in the positive electrode active material layer 135 may comprise a material including lithium (Li) ions. The positive electrode active material may reversibly intercalate and deintercalate lithium ions. That is, the positive electrode active material may contain lithium ions and serve to provide the lithium ions to the negative electrode when the all-solid-state battery is being charged. The positive electrode active material may affect the capacity and output of the all-solid-state battery.

For example, the positive electrode active material may include at least one selected from the group consisting of compounds represented by the following chemical formulae: LiₐA_{3-b}M_{b}D₂ (wherein 0.90≤a≤1.8 and 0≤b≤0.5); LiₐE_{1-b}M_{b}O_{2-c}D_{c} (wherein 0.90≤a≤1.8, 0≤b≤0.5, and 0≤c≤0.05); LiE_{2-b}M_{b}O_{4-c}D_{c} (wherein 0≤b≤0.5 and 0≤c≤0.05); LiₐNi_{2-b-c}Co_{b}M_{c}D_{α} (wherein 0.90≤a≤1.8, 0≤b≤0.5, 0≤c≤0.05, and 0<α≤2); LiₐNi_{1-b-c}Co_{b}M_{c}O_{2-α}X_{α} (wherein 0.90≤a≤1.8, 0≤b≤0.5, 0≤c≤0.05, and 0<α<2); Liₐ Ni_{1-b-c}Co_{b}M_{c}O_{2-α}X₂ (wherein 0.90≤a≤1.8, 0≤b≤0.5, 0≤c≤0.05, and 0<α<2); LiₐNi_{1-b-c} Mn_{b}M_{c}D_{α} (wherein 0.90≤a≤1.8, 0≤b≤0.5, 0≤c≤0.05, and 0<α≤2); LiₐNi_{1-b-c}Mn_{b}M_{c} O_{2-α}X_{α} (wherein 0.90≤a≤1.8, 0≤b≤0.5, 0≤c≤0.05, and 0<α<2); LiₐNi_{1-b-c}Mn_{b}M_{c}O_{2-α}X₂ (wherein 0.90≤a≤1.8, 0≤b≤0.5, 0≤c≤0.05, and 0<α<2); LiₐNi_{b}E_{c}G_{d}O₂ (wherein 0.90≤a≤1.8, 0≤b≤0.9, 0≤c≤0.5, and 0.001≤d≤0.1); LiₐNi_{b}Co_{c}Mn_{d}GₑO₂ (wherein 0.90≤a≤1.8, 0≤b≤0.9, 0≤c≤0.5, 0≤d≤0.5, and 0.001≤e≤0.1); LiₐNiG_{b}O₂ (wherein 0.90≤a≤1.8 and 0.001≤b≤0.1); LiₐCoG_{b}O₂ (wherein 0.90≤a≤1.8 and 0.001≤b≤0.1); LiₐMnG_{b}O2 (wherein 0.90≤a≤1.8 and 0.001≤b≤0.1); LiₐMn₂G_{b}O₄ (wherein 0.90≤a≤1.8 and 0.001≤b≤0.1); QO₂; QS₂; LiQS₂; V₂O₅; LiV₂O₂; LiRO₂; LiNiVO₄; Li_{(3-f)}J₂(PO₄)₃ (wherein 0≤f≤2); Li_{(3-f)}Fe₂(PO₄)₃ (wherein 0≤f≤2); and LiFePO₄. In the above chemical formulas, A represents Ni, Co, or Mn M represents Al, Ni, Co, Mn, Cr, Fe, Mg, Sr, V, Nb, Ti, or a rare-earth element, D represents O, F, S, or P, E represents Co or Mn, X represents F, S, or P, G represents Al, Cr, Mn, Fe, Mg, La, Ce, Sr, or V, Q represents Ti, Mo, or Mn, R represents Cr, V, Fe, Sc, or Y, and J represents V, Cr, Mn, Co, Ni, or Cu.

The positive electrode active material may also include LiCoO₂, LiMnₓO₂ₓ (wherein x is 1 or 2), LiNi₁₋ₓMnₓO₂ₓ (wherein 0<x<1), LiNi_{1-x-y}CoₓMn_{y}O₂ (wherein 0≤x≤0.5 and 0≤y≤0.5), LiFePO₄, TiS₂, FeS₂, TiS₃, or FeS₃, but the present disclosure is not limited thereto.

The positive electrode active material may optionally include a conductive material and a binder. However, because an organic material such as a binder decomposes during the sintering process, the organic material may not remain on the positive electrode active material layer of the finally obtained positive electrode current collector.

The conductive material is not particularly limited as long as it has conductivity without causing a chemical change in the all-solid-state battery 1000. For example, graphite such as natural graphite and artificial graphite; carbon-based materials such as carbon black, acetylene black, Ketjenblack®, channel black, furnace black, lamp black, and thermal black; conductive fibers such as carbon fibers, metal fibers, etc.; carbon fluoride; metal components such as lithium (Li), tin (Sn), aluminum (Al), nickel (Ni), copper (Cu), etc., oxides thereof, nitrides thereof, or fluorides thereof; conductive whiskers such as zinc oxide or potassium titanate; conductive metal oxide such as titanium oxide; and conductive materials such as polyphenylene derivatives, etc. may be used.

The binder may be used to improve the bonding forces of the active material, the conductive material, and the like. The binder may include, but not limited to, at least one selected from the group consisting of polyvinylidene fluoride, polyvinyl alcohol, carboxymethylcellulose (CMC), starch, hydroxypropylcellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubber (SBR), fluoro-rubber, and various copolymers, etc.

Meanwhile, the positive electrode layer 130 may further contain a solid electrolyte component. The solid electrolyte component may contain one or more of the above-mentioned components, and may serve as an ionic conduction channel in the positive electrode layer. Therefore, it is possible to reduce interface resistance.

The negative electrode layer 150 may be exposed outside of the laminate 100 from the second surface S2 of the laminate 100, and may be connected to the second external electrode 400.

Referring to FIG. 3 and FIG. 4B, the negative electrode layer 150 may include a negative electrode current collector 153, a first negative electrode active material layer 155, and a second negative electrode active material layer 156.

For example, the negative electrode current collector 153 may include a plate-shaped member or a thin member. As another example, the negative electrode current collector 153 may include a porous body having a reticulate shape, a mesh shape, or the like.

The negative electrode current collector 153 may include a first surface 153a and a second surface 153b. The first surface 153a and the second surface 153b oppose each other in the thickness direction (T-axis direction).

For example, the negative electrode current collector 153 may include, but not limited to, a porous metal plate made of, for example, stainless steel, nickel (Ni), copper (Cu), tin (Sn), aluminum (Al), or an alloy thereof.

In addition, the negative electrode current collector 153 may be coated with an oxidation-resistant metal or alloy film to prevent oxidation.

The negative electrode current collector 153, like the positive electrode current collector 133, may include a conductive carbon-based material, and may include one or more types of solid electrolytes. The negative electrode current collector 153 may be identical to the negative electrode active material layers 155 and 156.

The first negative electrode active material layer 155 and the second negative electrode active material layer 156 may include negative electrode active materials and be disposed on a surface of the negative electrode current collector 153. The negative electrode active material layer 155 may be formed by printing a negative electrode active material on one or both surfaces of the negative electrode current collector 153. However, the method of forming the negative electrode active material layer is not limited thereto.

The negative electrode active material in the negative electrode active material layer 155 may store the lithium ions that have moved from the positive electrode and release the lithium ions when the all-solid-state battery is discharged, thereby generating electrical energy. A carbon-based material, silicon, a silicon oxide, a silicon-based alloy, a silicon-carbon-based material composite, tin, a tin-based alloy, a tin-carbon composite, a metal oxide, or a combination thereof may be used as the negative electrode active material. The negative electrode active material may contain a lithium metal and/or a lithium metal alloy.

The lithium metal alloy may contain lithium, and metal/metalloid capable of making an alloy with lithium. For example, the metal/metalloid capable of making an alloy with lithium may be Si, Sn, Al, Ge, Pb, Bi, Sb, Si-AM alloys (wherein AM is an alkali metal, an alkaline earth metal, an element in group 13 to group 16, a transition metal, a ram-earth element, or a combination thereof, and does not include Si), Sn-AM alloys (wherein AM is an alkaline metal, an alkaline earth metal, an element in group 13 to group 16, a transition metal, a transition metal oxide such as lithium titanium oxide (Li₄Ti₅O₁₂), a rare-earth element, or combinations thereof, and does not include Sn), MnOₓ (wherein 0<x≤2), and the like.

The element AM may include Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or combinations thereof.

In addition, the oxide of the metal/metalloid capable of making an alloy with lithium may include lithium titanium oxide, vanadium oxide, lithium vanadium oxide, SnO₂, SiOₓ (wherein 0<x<2), or the like. For example, the negative electrode active material may contain one or more elements selected from a group consisting of the elements in group 13 to group 16 of the periodic table of elements. For example, the negative electrode active material may contain one or more elements selected from a group consisting of Si, Ge, and Sn.

The carbon-based material may include crystalline carbon, amorphous carbon, or a mixture thereof. The crystalline carbon may be graphite such as natural graphite or artificial graphite that is in a shapeless, disc-shaped, flake-shaped, globular, or fibrous form. In addition, the amorphous carbon may include, but not limited to, soft carbon (low-temperature calcined carbon), hard carbon, mesophase pitch carbide, calcined cokes, graphene, carbon black, fullerene soot, carbon nanotube, carbon fiber, or the like.

The silicon may include at least one selected from the group consisting of Si, SiOₓ (wherein 0<x<2, for example, 0.5 to 1.5), Sn, SnO₂, or silicon-containing metal alloys, and mixtures thereof. For example, the silicon-containing metal alloy may include silicon, and one or more of Al, Sn, Ag, Fe, Bi, Mg, Zn, In, Ge, Pb, or Ti.

The negative electrode active material may optionally include a conductive material and a binder.

The conductive material is not particularly limited as long as it has conductivity without causing a chemical change in the all-solid-state battery 1000. For example, graphite such as natural graphite and artificial graphite; carbon-based materials such as carbon black, acetylene black, Ketjenblack®, channel black, furnace black, lamp black, and thermal black; conductive fibers such as carbon fibers, metal fibers, etc.; carbon fluoride; metal components such as lithium (Li), tin (Sn), aluminum (Al), nickel (Ni), copper (Cu), etc., oxides thereof, nitrides thereof, or fluorides thereof; conductive whiskers such as zinc oxide or potassium titanate; conductive metal oxide such as titanium oxide; or conductive materials such as polyphenylene derivatives, etc. may be used.

The binder may be used to improve the bonding forces of the active material, the conductive material, and the like. The binder may include, but not limited to, at least one selected from the group consisting of polyvinylidene fluoride, polyvinyl alcohol, carboxymethylcellulose (CMC), starch, hydroxypropylcellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubber (SBR), fluoro-rubber, and various copolymers, etc.

The upper protective layer 160 and the lower protective layer 170 may be outermost layers respectively disposed on the fifth surface S5 and the sixth surface S6 of the laminate 100. That is, the upper protective layer 160 may be the outermost layer on the fifth surface S5 of the laminate 100, and the lower protective layer 170 may be the outermost layer on the sixth surface S6 of the laminate 100. The upper protective layer 160 and the lower protective layer 170 may improve reliability of moisture resistance by preventing moisture penetration and prevent damage caused by physical and chemical stress.

The upper protective layer 160 and the lower protective layer 170 may be insulation layers including an insulating material, i.e., a material that is not electrically (ionically) conductive.

The upper protective layer 160 and the lower protective layer 170 may include, but not limited to, at least one selected from the group consisting of ceramic materials, e.g., alumina (Al₂O, aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), mixtures thereof, oxides thereof and/or nitrides thereof, and any other suitable ceramic material. In addition, the upper protective layer 160 and the lower protective layer 170 may optionally include the above-mentioned solid electrolyte and may include one or more types of solid electrolytes. However, the present disclosure is not limited thereto.

For example, the margin portion 180 may be disposed on the solid electrolyte layer 110 in a region excluding the region where the positive electrode layer 130 or the negative electrode layer 150 is disposed. If the positive electrode layer 130 is disposed on the solid electrolyte layer 110, the margin portion 180 may be disposed in an area excluding the area where the positive electrode layer 130 is disposed. Similarly, if the negative electrode layer 150 is disposed on the solid electrolyte layer 110, the margin portion 180 may be disposed in the region excluding the region where the negative electrode layer 150 is disposed.

Referring to FIG. 3, the margin portion 180 may comprise a portion of the first surface S1 and a portion of the second surface S2 of the laminate 100. For example, the first margin portion 181 may comprise a portion of the second surface S2 of the laminate 100, and the second margin portion 183 may comprise a portion of the first surface S1 of the laminate 100. On the other hand, although not shown in the drawings, the margin portion 180 may comprise a portion of the third surface S3 and a portion of the fourth surface S4 of the laminate 100.

The margin portion 180 may be disposed to compensate for a level difference between the solid electrolyte layer 110 and the positive electrode layer 130 and a level difference between the solid electrolyte layer 110 and the negative electrode layer 150. For example, the margin portion 180 may be disposed on the same surface as the positive electrode layer 130 and the negative electrode layer 150. The margin portion 180 may compensate for a level difference between the solid electrolyte layer 110 and the positive electrode layer 130 or a level difference between the solid electrolyte layer 110 and the negative electrode layer 150. This increases the density between the solid electrolyte layer 110 and the electrode layers, which may prevent interlayer delamination or warping caused by sintering during a process of manufacturing the all-solid-state battery.

The margin portion 180 may include an insulating material, i.e., a material that is not electrically (ionically) conductive.

The margin portion 180 may include, but not limited to, at least one selected from the group consisting of ceramic materials, e.g., alumina (Al₂O₃), aluminum nitride (AlN), beryllium oxide (BeO), boron nitride (BN), silicon (Si), silicon carbide (SiC), silica (SiO₂), silicon nitride (Si₃N₂), gallium arsenide (GaAs), gallium nitride (GaN), barium titanate (BaTiO₃), zirconium dioxide (ZrO₂), mixtures thereof, oxides thereof and/or nitrides thereof, and any other suitable ceramic material.

Meanwhile, the margin portion 180 may optionally contain the above-mentioned solid electrolyte, and may include one or more types of solid electrolytes. However, the present disclosure is not limited thereto.

In addition, in the margin portion 180, a material having a low ionic conductivity and electrical conductivity, i.e., an insulating material, may be present, and a material having ionic conductivity (or electrical conductivity) similar to the ionic conductivity (or electrical conductivity) of the solid electrolyte may be present. For example, when a material having ionic conductivity (or electrical conductivity) similar to the ionic conductivity (or electrical conductivity) of the solid electrolyte is present in the margin portion, that material may be a material identical to or different from the solid electrolyte in other regions. As another example, a material having ionic conductivity (or electrical conductivity) similar to the ionic conductivity (or electrical conductivity) of the solid electrolyte and an insulating material may coexist in the margin portion.

The first thin-film electrode 210 and the second thin-film electrode 220 are disposed on the outer surfaces of the laminate 100.

The first thin-film electrode 210 is directly connected to the positive electrode layer 130 and the solid electrolyte layer 110 on the first surface S1 of the laminate 100. For example, the first thin-film electrode 210 may cover the first surface S1 of the laminate 100.

The first thin-film electrode 210 is a layer of atoms deposited, as opposed to a baked electrode with a conductive paste, and may be formed using thin-film formation methods such as plating, sputtering, vacuum evaporation, and chemical vapor deposition (CVD). In other words, the first thin-film electrode is an electrode (i.e., a metal electrode) formed by the uniform deposition atoms, so it is uniform in thickness and contains fine grains of tens to hundreds of nanometers (nm) in size. On the other hand, the baked electrode has particles of several micrometers (um) to tens of micrometers (um) in size, either singly or with some connected structures. Meanwhile, the microstructure of thin-film electrodes formed by vapor deposition without the use of organic materials such as binders and baked electrodes can be distinguished by the presence or absence of organic materials. Using the thin-film formation method, it is possible to form a thin-film electrode of the desired thickness while suppressing the variation in the thickness of the thin film electrode, resulting in a thin and uniform thin-film electrode. For example, the first thin-film electrode 210 may be a sputter electrode.

Electrodes formed by methods other than the thin-film deposition methods described above, such as paste dip, may not be sufficiently uniform in thickness.

A thickness of the first thin-film electrode 210 may be 50 nm or more and 1 μm or less. If the thickness of the first thin-film electrode 210 is less than 50 nm, connectivity between the positive electrode layer 130 and the first external electrode 300 may be low, which may not be effective in improving the charge/discharge characteristics. If the thickness of the first thin-film electrode 210 exceeds 1 lpm, the time and cost to form the thin-film electrode may increase, resulting in lower productivity.

Meanwhile, the thickness of the first thin-film electrode 210 may be 50 nm or more and 500 nm or less, and if the thickness of the first thin-film electrode 210 is 500 nm or more, the improvement in charge/discharge characteristics may be saturated.

Here, the thickness of the thin-film electrode may mean an average thickness. The average thickness of the thin-film electrode may be an arithmetic mean of the values measured at five evenly spaced points in the thickness direction (T-axis direction), based on a 20,000 magnification scanning electron microscope (SEM) photograph of a length direction (L-axis direction)-thickness direction (T-axis direction) cross section at the center of the laminate 100 in the width direction (W-axis direction), of one thin-film electrode shown in the cross section photograph described above.

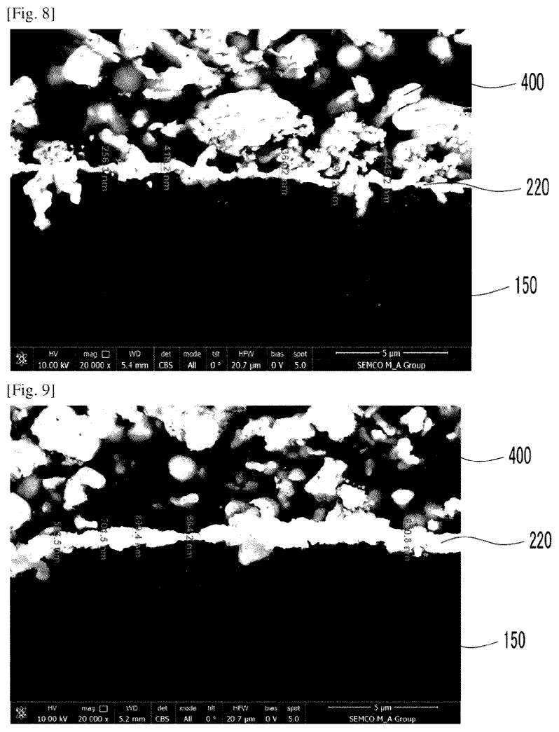

FIG. 5 is a scanning electron microscope photograph showing a result of depositing the first thin-film electrode with a 300 nm to 400 nm sputtering target.

Referring to FIG. 5, thicknesses measured at five points on the first thin-film electrode 210 are 202.3 nm, 377.7 nm, 283.3 nm, 364.2 nm, and 269.8 nm, respectively. Because the arithmetic mean of these values is 299.5 nm, so the thickness of the first thin-film electrode 210 may be 299.5 nm.

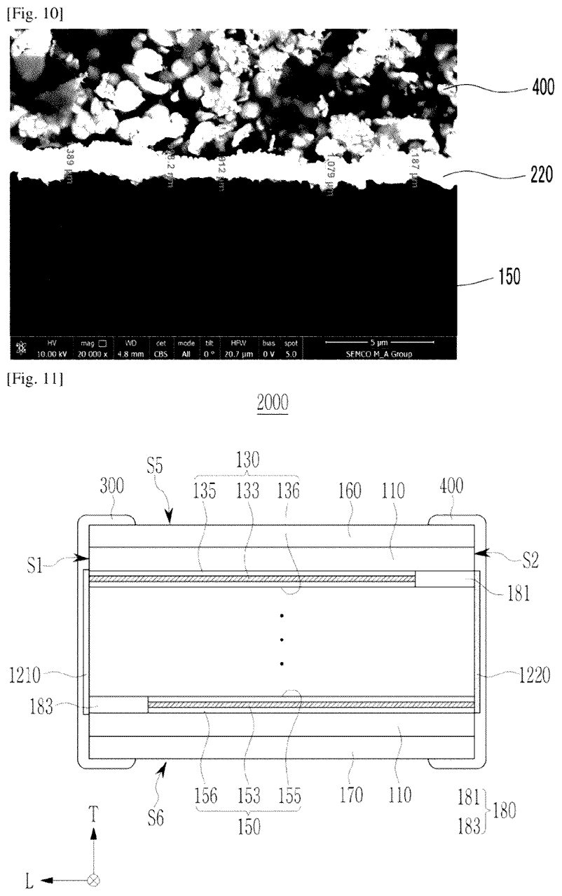

FIG. 6 is a scanning electron microscope photograph showing a result of depositing the first thin-film electrode with a 500 nm to 600 nm sputtering target.

Referring to FIG. 6, thicknesses measured at five points on the first thin-film electrode 210 are 741.9 nm, 634.0 nm, 647.5 nm, 795.9 nm, and 607.0 nm, respectively. Because the arithmetic mean of these values is 685.3 nm, the thickness of the first thin-film electrode 210 may be 685.3 nm.

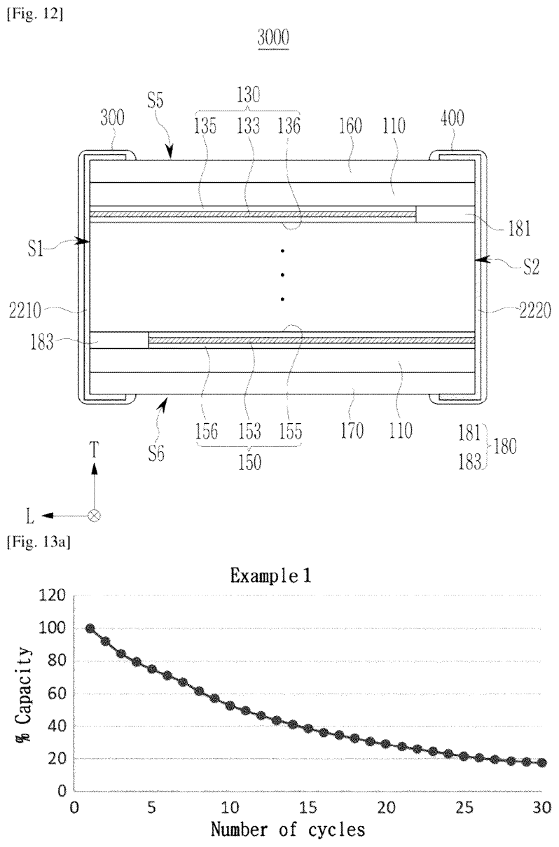

FIG. 7 is a scanning electron microscope photograph showing a result of depositing the first thin-film electrode with a 1000 nm sputtering target.

Referring to FIG. 7, thicknesses measured at five points on the first thin-film electrode 210 are 849.8 nm, 1025 nm, 741.9 nm, 822.9 nm, and 809.4 nm, respectively. Because the arithmetic mean of these values is 849.8 nm, the thickness of the first thin-film electrode 210 may be 849.8 nm.

The first thin-film electrode 210 may include platinum (Pt), gold (Au), nickel (Ni), chromium (Cr), molybdenum (Mo), or a combination thereof.

The second thin-film electrode 220 is directly connected to the negative electrode layer 150 and the solid electrolyte layer 110 on the second surface S2 of the laminate 100. For example, the second thin-film electrode 220 may cover the second surface S2 of the laminate 100.

The second thin-film electrode 220 is a layer of atoms deposited, as opposed to a baked electrode with a conductive paste, and may be formed using thin-film formation methods such as plating, sputtering, vacuum evaporation, and chemical vapor deposition (CVD). Using the thin-film formation method, it is possible to form a thin and uniform thin-film electrode. For example, the second thin-film electrode 220 may be a sputter electrode.

A thickness of the second thin-film electrode 220 may be 50 nm or more and 1 μm or less. Meanwhile, the thickness of the second thin-film electrode 220 may be 50 nm or more and 500 nm or less. If the thickness of the second thin-film electrode 220 is less than 50 nm, connectivity between the negative electrode layer 150 and the second external electrode 400 may be low, which may not be effective in improving the charge/discharge characteristics. If the thickness of the second thin-film electrode 220 exceeds 1 μm, the time and cost to form the thin-film electrode may increase, resulting in lower productivity.

Meanwhile, the thickness of the second thin-film electrode 220 may be 50 nm or more and 500 nm or less, and if the thickness of the second thin-film electrode 220 is 500 nm or more, the improvement in charge/discharge characteristics may be saturated.

Here, the thickness of the thin-film electrode may mean an average thickness. The average thickness of the thin-film electrode may be an arithmetic mean of the values measured at five evenly spaced points in the thickness direction (T-axis direction), based on a 20,000 magnification scanning electron microscope (SEM) photograph of a length direction (L-axis direction)-thickness direction (T-axis direction) cross section at the center of the laminate 100 in the width direction (W-axis direction), of one thin-film electrode shown in the cross section photograph described above.

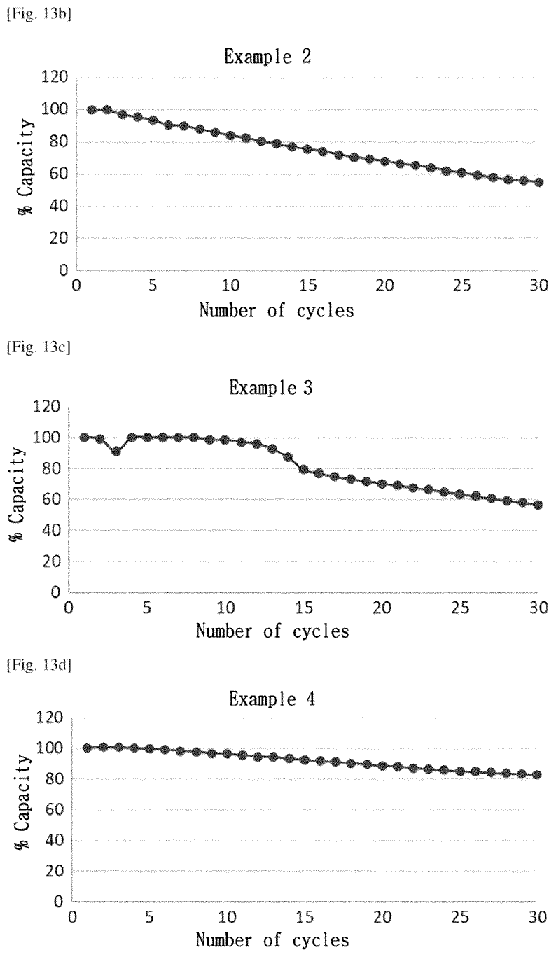

FIG. 8 is a scanning electron microscope photograph showing a result of depositing the second thin-film electrode with a 300 nm to 400 nm sputtering target.

Referring to FIG. 8, thicknesses measured at five points on the second thin-film electrode 220 are 256.3 nm, 418.2 nm, 364.2 nm, 391.2 nm, and 445.2 nm, respectively. Because the arithmetic mean of these values is 375 nm, the thickness of the second thin-film electrode 220 may be 375 nm.

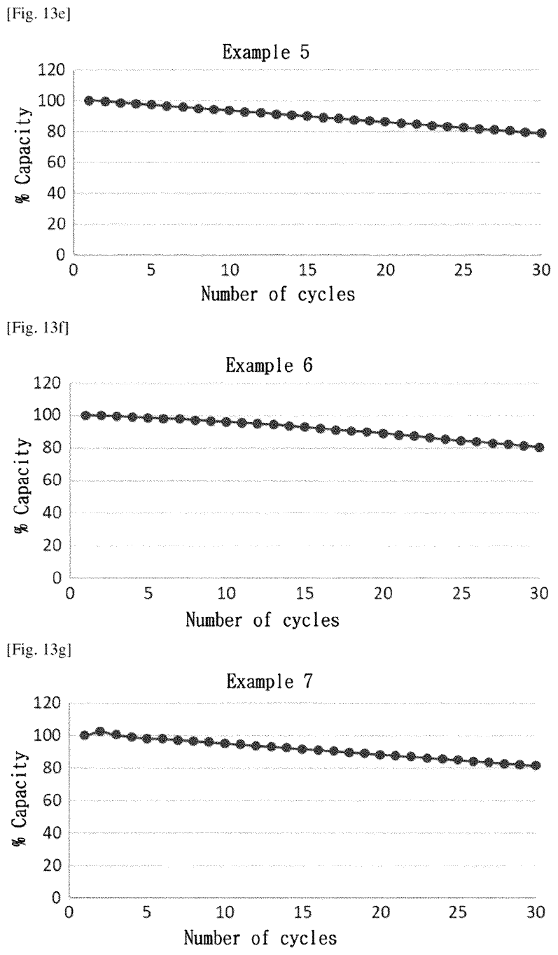

FIG. 9 is a scanning electron microscope photograph showing a result of depositing the second thin-film electrode with a 500 nm to 600 nm sputtering target.

Referring to FIG. 9, thicknesses measured at five points on the second thin-film electrode 220 are 593.5 nm, 701.5 nm, 809.4 nm, 364.2 nm, and 930.8 nm, respectively. Because the arithmetic mean of these values is 679.9 nm, the thickness of the second thin-film electrode 220 may be 679.9 nm.

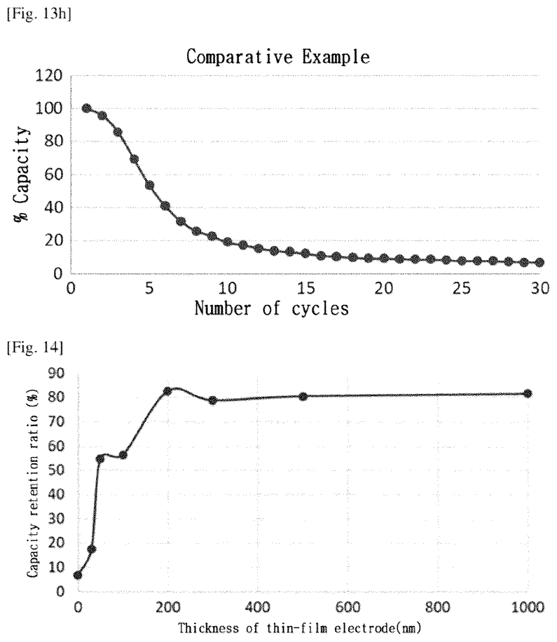

FIG. 10 is a scanning electron microscope photograph showing a result of depositing the second thin-film electrode with a 1000 nm sputtering target.

Referring to FIG. 10, thicknesses measured at five points on the second thin-film electrode 220 are 1389 nm, 998.2 nm, 1012 nm, 1079 nm, and 1187 nm, respectively. Because the arithmetic mean of these values is 1133 nm, the thickness of the second thin-film electrode 220 may be 1133 nm.

Additionally, the second thin-film electrode 220 may include platinum (Pt), gold (Au), nickel (Ni), chromium (Cr), molybdenum (Mo), or a combination thereof.

The first external electrode 300 and the second external electrode 400 are disposed outside the laminate 100.

The first external electrode 300 is connected to the first thin-film electrode 210 on the first surface S1 of the laminate 100.

For example, the first external electrode 300 may extend onto the third surface S3, the fourth surface S4, the fifth surface S5, and the sixth surface S6 of the laminate 100 and partially cover the respective surfaces.

The second external electrode 400 is connected to the second thin-film electrode 220 on the second surface S2 of the laminate 100.

For example, the second external electrode 400 may extend onto the third surface S3, the fourth surface S4, the fifth surface S5, and the sixth surface S6 of the laminate 100 and partially cover the respective surfaces.

Meanwhile, in some embodiments, the first external electrode 300 and the second external electrode 400 may extend onto one of the fifth surface S5 and the sixth surface S6 and partially cover the corresponding surface.

For example, the first external electrode 300 and the second external electrode 400 may be fired electrodes including a conductive metal and glass. As another example, the first external electrode 300 and the second external electrode 400 may be resin-based electrodes including a conductive metal and a base resin, and in which case the base resin may be an epoxy resin.

For example, the first external electrode 300 and the second external electrode 400 may be formed by applying a paste comprising a conductive metal to the first surface S1 and the second surface S2 of the laminate 100, respectively, or by transferring a dried film of a conductive paste to the laminate 100 and then firing the transferred film, but a method for forming the first external electrode 300 and the second external electrode 400 is not limited thereto. Meanwhile, the conductive metal may include, for example, copper (Cu), nickel (Ni), tin (Sn), palladium (Pd), platinum (Pt), gold (Au), silver (Ag), tungsten (W), titanium (Ti), lead (Pb), or an alloy thereof, but the present disclosure is not limited thereto.

On the other hand, by forming a plating layer on the first external electrode 3X) and the second external electrode 400, respectively, the mounting characteristics of the external electrode may also be improved. The plating layer may include at least one selected from the group consisting of copper (Cu), nickel (Ni), tin (Sn), palladium (Pd), platinum (Pt), gold (Au), silver (Ag), tungsten (W), titanium (Ti), lead (Pb), and an alloy thereof, but the present disclosure is not limited thereto. The plating layer may be formed to have one or more layers.

As described above, according to the present embodiment, the first thin-film electrode 210 and the second thin-film electrode 220 may be formed thinly and uniformly using a thin-film deposition method. The first thin-film electrode 210 formed in this manner may have a uniform interface with the first external electrode 300, and the formed second thin-film electrode 220 may have a uniform interface with the second external electrode 400. Therefore, there is a good connectivity between the first thin-film electrode 210 and the first external electrode 300, and a good connectivity between the second thin-film electrode 220 and the second external electrode 400. In other words, the presence of the first thin-film electrode 210 allows current to flow reliably between the positive electrode layer 130 and the first external electrode 300, and the presence of the second thin-film electrode 220 allows current to flow reliably between the negative electrode layer 150 and the second external electrode 400. Therefore, the all-solid-state battery according to the present embodiment is capable of stable charging and discharging.

FIG. 11 is a cross-sectional view schematically showing an all-solid-state battery according to another embodiment.

Referring to FIG. 11, an all-solid-state battery 2000 includes a laminate 100, a first thin-film electrode 1210, a second thin-film electrode 1220, a first external electrode 300, and a second external electrode 400.

The first thin-film electrode 1210 is connected to the positive electrode layer 130 on the first surface S1 of the laminate 100.

The first thin-film electrode 1210 covers a portion of the first surface S1 of the laminate 100.

For example, the first thin-film electrode 1210 may cover a region corresponding to a region of the first surface S1 of the laminate 100 corresponding to a region from the electrode layer closest to the upper protective layer 160 to the electrode layer closest to the lower protective layer 170.

In other words, the first thin-film electrode 1210 may not cover regions of the first surface S1 of the laminate 100 corresponding to regions where the electrode layer is not disposed. In this case, the first thin-film electrode 1210 may not cover a region between the electrode layer closest to the upper protective layer 160 and the fifth surface S5 of the laminate 100, and may not cover a region between the electrode layer closest to the lower protective layer 170 and the sixth surface S6 of the laminate 100.

The second thin-film electrode 1220 is connected to the negative electrode layer 150 on the second surface S2 of the laminate 100.

The second thin-film electrode 1220 covers a portion of the second surface S2 of the laminate 100.

For example, the second thin-film electrode 1220 may cover a region corresponding to a region of the second surface S2 of the laminate 100 corresponding to a region from the electrode layer closest to the upper protective layer 160 to the electrode layer closest to the lower protective layer 170.

In other words, the second thin-film electrode 1220 may not cover regions of the second surface S2 of the laminate 100 corresponding to regions where the electrode layer is not disposed. In this case, the second thin-film electrode 1220 may not cover a region between the electrode layer closest to the upper protective layer 160 and the fifth surface S5 of the laminate 100, and may not cover a region between the electrode layer closest to the lower protective layer 170 and the sixth surface S6 of the laminate 100.

The first external electrode 300 is connected to the first thin-film electrode 1210 on the first surface S1 of the laminate 100. The first external electrode 300 may cover the first thin-film electrode 1210, and may cover a portion of the first surface S1 of the laminate 100 where the first thin-film electrode 1210 is not disposed. That is, the first external electrode 300 may cover a region between the electrode layer closest to the upper protective layer 160 and the fifth surface S5 of the laminate 100, and may cover a region between the electrode layer closest to the lower protective layer 170 and the sixth surface S6 of the laminate 100.

The second external electrode 400 is connected to the second thin-film electrode 1220 on the first surface S1 of the laminate 100. The second external electrode 400 may cover the second thin-film electrode 1220, and may cover a portion of the first surface S1 of the laminate 100 where the second thin-film electrode 1220 is not disposed. That is, the second external electrode 400 may cover a region between the electrode layer closest to the upper protective layer 160 and the fifth surface S5 of the laminate 100, and may cover a region between the electrode layer closest to the lower protective layer 170 and the sixth surface S6 of the laminate 100.

In this way, when the first thin-film electrode 1210 is disposed on a portion of the first surface S1 of the laminate 100 and the second thin-film electrode 1220 is disposed on a portion of the second surface S2 of the laminate 100, thin film electrodes of various shapes may be obtained.

Because the remaining component except for the above component are the same as that of the all-solid-state battery shown in FIG. 1, a redundant description thereof will be omitted.

FIG. 12 is a cross-sectional view schematically showing an all-solid-state battery according to another embodiment.

Referring to FIG. 12, the all-solid-state battery 3000 includes a laminate 100, a first thin-film electrode 2210, a second thin-film electrode 2220, a first external electrode 300, and a second external electrode 400.

The first thin-film electrode 2210 is connected to the positive electrode layer 130 on the first surface S1 of the laminate 100. The first thin-film electrode 2210 covers the first surface S1 of the laminate 100, and a portion of the fifth surface S5 and a portion of the sixth surface S6 of the laminate 100. Meanwhile, the first thin-film electrode 2210 may cover a portion of the third surface S3 and a portion of the fourth surface S4 of the laminate 100.

The second thin-film electrode 2220 is connected to the negative electrode layer 150 on the second surface S2 of the laminate 100. The second thin-film electrode 2220 covers the second surface S2 of the laminate 100 and a portion of the fifth surface S5 and a portion of the sixth surface S6 of the laminate 100. Meanwhile, the second thin-film electrode 2220 may cover a portion of the third surface S3 and a portion of the fourth surface S4 of the laminate 100.

The first external electrode 300 may completely cover the first thin-film electrode 2210. Accordingly, the first external electrode 300 may be connected to the first thin-film electrode 2210 on the first surface S1, the fifth surface S5, and the sixth surface S6 of the laminate 100. Meanwhile, the first external electrode 300 may be connected to the first thin-film electrode 2210 on the third surface S3 and the fourth surface S4 of the laminate 100.

The second external electrode 400 may completely cover the second thin-film electrode 2220. Accordingly, the second external electrode 400 may be connected to the second thin-film electrode 2220 on the second surface S2, the fifth surface S5, and the sixth surface S6 of the laminate 100. Meanwhile, the second external electrode 400 may be connected to the second thin-film electrode 2220 on the third surface S3 and the fourth surface S4 of the laminate 100.

In this way, if the first thin-film electrode 1210 is disposed not only on the first surface S1 of the laminate 100 but also on the fifth surface S5 and the sixth surface S6 and the second thin-film electrode 1220 is disposed not only on the second surface S2 of the laminate 100 but also on the fifth surface S5 and the sixth surface S6, the connectivity with the external electrode may be improved and moisture penetration may be prevented. The interface between the external electrode and the laminate can be vulnerable to moisture penetration, and by placing dense thin-film electrodes not only on the first and second surfaces of the laminate, but also on the fifth and sixth surfaces, it not only strengthens the connectivity with the external electrode, but also acts as a barrier layer to prevent moisture penetration, improving moisture resistance properties.

Because the remaining component except for the above component are the same as that of the all-solid-state battery of FIG. 1, a redundant description thereof will be omitted.

Hereinafter, specific embodiments of the present disclosure are presented. However, the embodiments described below are only intended to specifically illustrate or describe the present disclosure, and should not limit the scope of the present disclosure.

### Manufacturing Example: Manufacture of all-Solid-State Battery

### Example 1

A plurality of striped positive electrode layers was printed on a solid electrolyte layer (green sheet) in the order of a positive electrode active material layer, a positive electrode collector, a positive electrode active material layer, and then the space between the positive electrode layers was filled with insulating material to form a positive electrode sheet.

A plurality of striped negative electrode layers was printed on a solid electrolyte layer (green sheet) in the order of a negative electrode active material layer, a negative electrode collector, a negative electrode active material layer, and then the space between the negative electrode layers was filled with insulating material to form a negative electrode sheet.

The positive and negative electrode sheets were stacked alternately to form a green chip.

The green chip was cut to form a laminate.

The laminate was fired in an air or nitrogen atmosphere at 400° C. to 550° C.

A first platinum (Pt) thin-film electrode and a second platinum (Pt) thin-film electrode were formed on a surface of the laminate with a thickness of 30 nm by a sputtering method.

An all-solid-state battery was prepared by applying a conductive paste for a fir % t external electrode to the first platinum (Pt) thin-film electrode and a surface of a laminate, applying a conductive paste for a second external electrode to the second platinum (P) thin-film electrode and a surface of a laminate, and cooling to form a first external electrode and a second external electrode.

### Example 2

Example 2 was the same as Example 1 except that the first platinum (Pt) thin-film electrode and the second platinum (Pt) thin-film electrode were formed with a thickness of 50 nm in Example 2.

### Example 3

Example 3 was the same as Example 1 except that the first platinum (Pt) thin-film electrode and the second platinum (Pt) thin-film electrode were formed with a thickness of 100 nm in Example 3.

### Example 4

Example 4 was the same as Example 1 except that the first platinum (Pt) thin-film electrode and the second platinum (Pt) thin-film electrode were formed with a thickness of 200 nm in Example 4.

### Example 5

Example 5 was the same as Example 1 except that the first platinum (Pt) thin-film electrode and the second platinum (Pt) thin-film electrode were formed with a thickness of 300 nm in Example 5.

### Example 6

Example 6 was the same as Example 1 except that the first platinum (Pt) thin-film electrode and the second platinum (Pt) thin-film electrode were formed with a thickness of 500 nm in Example 6.

### Example 7

Example 7 was the same as Example 1 except that the first platinum (Pt) thin-film electrode and the second platinum (Pt) thin-film electrode were formed with a thickness of 1000 nm (1 μm) in Example 7.

### Comparative Example

Comparative Example was the same as Example 1 except that the first platinum (Pt) thin-film electrode and the second platinum (Pt) thin-film electrode were not formed in Comparative Example.

### Experimental Example: Performance of all-Solid-State Battery

Five all-solid-state batteries of each of Examples 1-7 and Comparative Example were manufactured, repeated charge/discharge cycle tests were performed on one representative sample of the five all-solid-state batteries, respectively. The test condition was as follows.

A charge/discharge current was 300 μA, a charge voltage cut (or a charging voltage cut-off) was 3.95 V, a discharge voltage cut (or a discharging voltage cut-off) was 2.0 V, at a room temperature of 25° C., and the number of charge/discharge cycles was 30.

The test results are shown in Table 1, FIGS. 13A to 1314, and FIG. 14.

TABLE 1

| Number of | | | | | | | | Comparative |
|---|---|---|---|---|---|---|---|---|
| cycles | Example 1 | Example 2 | Example 3 | Example 4 | Example 5 | Example 6 | Example 7 | Example |
| 1 | 100 | 100 | 100 | 100 | 100 | 100 | 100 | 100 |
| 2 | 92.0279069 | 99.607199 | 98.87494 | 100.6207 | 99.3202 | 99.80157 | 102.5438 | 95.77997 |
| 3 | 84.4024356 | 96.99103 | 91.00072 | 100.3672 | 98.53563 | 99.40101 | 100.4174 | 85.662194 |
| 4 | 79.1759085 | 95.274282 | 99.6786 | 99.91264 | 97.82091 | 98.83163 | 99.31255 | 69.509069 |
| 5 | 74.6930161 | 93.436207 | 99.74218 | 99.45408 | 97.08873 | 98.3788 | 98.16608 | 53.345242 |
| 6 | 70.8732173 | 90.499889 | 100 | 98.85899 | 96.35655 | 97.87324 | 98.01824 | 41.199374 |
| 7 | 66.9241733 | 89.75473 | 99.92466 | 98.22586 | 95.62437 | 97.63321 | 97.32833 | 31.832799 |
| 8 | 61.3147597 | 87.801866 | 99.8377 | 97.45154 | 94.89218 | 97.04467 | 96.63842 | 25.88256 |
| 9 | 56.7654525 | 85.776108 | 98.385 | 96.63644 | 94.16 | 96.4093 | 95.94851 | 22.801137 |
| 10 | 52.6475252 | 83.778927 | 98.38587 | 96.18143 | 93.42782 | 95.92684 | 95.2586 | 19.012563 |
| 11 | 49.4813322 | 82.312342 | 96.93419 | 95.36472 | 92.69564 | 95.43632 | 94.56869 | 17.42054 |
| 12 | 46.2565255 | 80.261157 | 95.84499 | 94.53656 | 91.96345 | 94.81968 | 93.87878 | 15.26867 |
| 13 | 43.6688791 | 78.664284 | 92.57783 | 94.05962 | 91.23127 | 94.19172 | 93.18887 | 13.95994 |
| 14 | 41.0337935 | 76.718927 | 87.12472 | 93.22663 | 90.49909 | 93.56898 | 92.49897 | 13.084129 |
| 15 | 38.463436 | 75.325962 | 79.39465 | 92.39235 | 89.7669 | 92.63128 | 91.80906 | 12.195797 |
| 16 | 36.1220514 | 73.985789 | 76.74881 | 91.56049 | 89.03472 | 92.00898 | 91.11915 | 10.968103 |
| 17 | 34.2698169 | 72.053026 | 74.82692 | 91.04583 | 88.30254 | 90.98634 | 90.42924 | 10.422614 |
| 18 | 32.4338171 | 70.295593 | 72.94569 | 90.21381 | 87.57036 | 90.34421 | 89.73933 | 9.7588157 |
| 19 | 30.6096245 | 69.322552 | 71.79087 | 89.37115 | 86.83817 | 89.69948 | 89.04942 | 9.2815512 |
| 20 | 28.8900087 | 67.918204 | 70.19068 | 88.51366 | 86.10599 | 89.05409 | 88.35951 | 9.2400305 |
| 21 | 27.2937347 | 66.462032 | 68.99841 | 87.99545 | 85.37381 | 87.9685 | 87.6696 | 8.9068885 |
| 22 | 25.8838437 | 65.108541 | 67.53419 | 87.12958 | 84.64163 | 87.27584 | 86.97969 | 8.6936999 |
| 23 | 24.3993152 | 63.8076 | 66.13796 | 86.26581 | 83.90944 | 86.22379 | 86.28978 | 8.6342607 |
| 24 | 22.9890026 | 61.972916 | 64.74173 | 85.65 | 83.17726 | 85.10596 | 85.59988 | 8.3770262 |
| 25 | 21.6575443 | 60.806864 | 63.3455 | 85.03 | 82.44508 | 84.46754 | 84.90997 | 7.7179368 |
| 26 | 20.4163203 | 59.114091 | 61.94927 | 84.57 | 81.7129 | 83.74766 | 84.22006 | 7.8988314 |
| 27 | 19.4514238 | 57.632007 | 60.55304 | 84.022 | 80.98071 | 82.86953 | 83.53015 | 7.6103339 |
| 28 | 18.6894202 | 56.38168 | 59.15681 | 83.516 | 80.24853 | 82.06285 | 82.84024 | 7.2714806 |
| 29 | 18.0016998 | 55.608672 | 57.76058 | 83.111 | 79.51635 | 81.25617 | 82.15033 | 7.0327165 |
| 30 | 17.3384109 | 54.824281 | 56.36435 | 82.587 | 78.78417 | 80.44949 | 81.46042 | 6.8154628 |

(Unit: % capacity)

Referring to FIGS. 13A to 13H, it may be seen that the all-solid-state batteries manufactured according to Examples 1-7 exhibited a superior discharge capacity to the all-solid-state battery manufactured according to Comparative Example throughout the total of 30 cycles.

Referring to FIG. 14, it may be seen that the capacity retention ratio of the thin-film electrode tends to increase with a thickness of 50 nm or mor e and saturates at thicknesses of 500 nm or more.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

1000: all-solid-state battery
100: laminate
110: solid electrolyte layer
130: positive electrode layer
133: positive electrode current collector
135, 136: positive electrode active material layer
150: negative electrode layer
153: negative electrode current collector
155, 156: negative electrode active material layer
160: upper protective layer
170: lower protective layer
180, 181, 183: margin portion
210: first thin-film electrode
220: second thin-film electrode
300: first external electrode
400: second external electrode

1. An all-solid-state battery comprising:
a laminate including a first surface and a second surface opposing each other in a first direction, a third surface and a fourth surface opposing each other in a second direction and connecting the first surface and the second surface, and a fifth surface and a sixth surface opposing each other in a third direction and connecting the first surface and the second surface, a positive electrode layer, a negative electrode layer, and a solid electrolyte layer disposed between the positive electrode layer and the negative electrode layer and including a solid electrolyte;
a first thin-film electrode that is directly connected to the positive electrode layer and the solid electrolyte layer on the first surface of the laminate;
a second thin-film electrode that is directly connected to the negative electrode layer and the solid electrolyte layer on the second surface of the laminate;
a first external electrode that is connected to the first thin-film electrode and covers at least a portion of the laminate; and
a second external electrode that is connected to the second thin-film electrode and covers at least a portion of the laminate.

2. The all-solid-state battery of claim 1, wherein the first external electrode and the second external electrode include silver (Ag).

3. The all-solid-state battery of claim 1, wherein the first external electrode and the second external electrode include a base resin and a conductive metal including silver (Ag).

4. The all-solid-state battery of claim 3, wherein the base resin includes an epoxy resin.

5. The all-solid-state battery of claim 1, wherein the first thin-film electrode and the second thin-film electrode am a sputter electrode.

6. The all-solid-state battery of claim 1, wherein a thickness of the first thin-film electrode is 50 nm or more and 1 μm or less, and a thickness of the second thin-film electrode is 50 nm or more and 1 μm or less.

7. The all-solid-state battery of claim 1, wherein a thickness of the first thin-film electrode is 50 nm or more and 500 nm or less, and a thickness of the second thin-film electrode is 50 nm or more and 500 nm or less.

8. The all-solid-state battery of claim 1, wherein at least one of a thickness of the first thin-film electrode and a thickness of the second thin-film electrode is 50 nm or more and 500 nm or less.

9. The all-solid-state battery of claim 1, wherein the first thin-film electrode covers a portion of the first surface of the laminate, and the second thin-film electrode covers a portion of the second surface of the laminate.

10. The all-solid-state battery of claim 8, wherein the first external electrode covers the first thin-film electrode and covers a portion of the first surface of the laminate where the first thin-film electrode is not disposed, and the second external electrode covers the second thin-film electrode and covers a portion of the second surface of the laminate where the second thin-film electrode is not disposed.

11. The all-solid-state battery of claim 10, wherein the first external electrode covers a portion of the fifth surface and a portion of the sixth surface of the laminate, and the second external electrode covers another portion of the fifth surface and another portion of the sixth surface of the laminate.

12. The all-solid-state battery of claim 1, wherein the first thin-film electrode entirely covers the first surface of the laminate, and the second thin-film electrode entirely covers the second surface of the laminate.

13. The all-solid-state battery of claim 12, wherein the first external electrode covers the first thin-film electrode and covers a portion of the fifth surface and a portion of the sixth surface of the laminate, and the second external electrode covers the second thin-film electrode and covers another portion of the fifth surface and another portion of the sixth surface of the laminate.

14. The all-solid-state battery of claim 1, wherein the first thin-film electrode entirely covers the first surface of the laminate and covers a portion of the fifth surface and a portion of the sixth surface of the laminate, and the second thin-film electrode entirely covers the second surface of the laminate and covers another portion of the fifth surface and another portion of the sixth surface of the laminate.

15. The all-solid-state battery of claim 14, wherein the first external electrode entirely covers the first thin-film electrode, and the second external electrode entirely covers the second thin-film electrode.

16. The all-solid-state battery of claim 1, wherein the first thin-film electrode and the second thin-film electrode each includes platinum (Pt), gold (Au), nickel (Ni), chromium (Cr), molybdenum (Mo), or combinations thereof.

17. The all-solid-state battery of claim 1, wherein the positive electrode layer includes a positive electrode current collector and a positive electrode active material layer, and the negative electrode layer includes a negative electrode active material layer.

18. An all-solid-state battery comprising:
a laminate including a first surface and a second surface opposing each other in a first direction, a third surface and a fourth surface opposing each other in a second direction and connecting the first surface and the second surface, and a fifth surface and a sixth surface opposing each other in a third direction and connecting the first surface and the second surface, a positive electrode layer, a negative electrode layer, and a solid electrolyte layer disposed between the positive electrode layer and the negative electrode layer and including a solid electrolyte;
a first external electrode disposed at least on the first surface;
a second external electrode disposed at least on the second surface;
a first metal electrode disposed on the first surface to connect the positive electrode layer to the first external electrode; and
a second metal electrode disposed on the second surface to connect the negative electrode layer to the second external electrode.

19. The all-solid-state battery of claim 18, wherein the first external electrode and the second external electrode include a base resin and a conductive metal including silver (Ag).

20. The all-solid-state battery of claim 18, wherein a metal included in the first metal electrode extends continuously from the positive electrode laver to the first external electrode, and
a metal included in the second metal electrode extends continuously from the negative electrode layer to the second external electrode.

21. The all-solid-state battery of claim 18, wherein one of a thickness of the first metal electrode and a thickness of the second metal electrode is 50 nm or more and 1 μm or less.

22. The all-solid-state battery of claim 18, wherein one of a thickness of the first metal electrode and a thickness of the second metal electrode is 50 nm or more and 500 nm or less.

23. The all-solid-state battery of claim 18, wherein one of a thickness of the first metal electrode and a thickness of the second metal electrode is 200 nm or more and 1 μm or less.

24. An all-solid-state battery comprising:
a laminate including a first surface and a second surface opposing each other in a first direction, a third surface and a fourth surface opposing each other in a second direction and connecting the first surface and the second surface, and a fifth surface and a sixth surface opposing each other in a third direction and connecting the first surface and the second surface, a positive electrode layer, a negative electrode layer, and a solid electrolyte layer disposed between the positive electrode layer and the negative electrode layer and including a solid electrolyte;
a first external electrode disposed at least on the first surface;
a second external electrode disposed at least on the second surface;
a first electrode disposed on the first surface to connect the positive electrode layer to the first external electrode and having a thickness of 1 μm or less; and
a second electrode disposed on the second surface to connect the negative electrode layer to the second external electrode and having a thickness of 1 μm or less.

25. The all-solid-state battery of claim 24, wherein the first external electrode and the second external electrode include a base resin and a conductive metal including silver (Ag).

26. The all-solid-state battery of claim 24, wherein one of the thickness of the first electrode and the thickness of the second electrode is 50 nm or more and 1 μm or less.

27. The all-solid-state battery of claim 24, wherein one of the thickness of the first electrode and the thickness of the second electrode is 50 nm or more and 500 nm or less.

28. The all-solid-state battery of claim 24, wherein one of the thickness of the first electrode and the thickness of the second electrode is 200 nm or more and 1 μm or less.
